(19) United States
(12) Patent Application Publication
(10) Pub. No.: US 2019/0270912 A1
(43) Pub. Date: Sep. 5, 2019

(54) Coating To Produce Dust-Repellant Glass

(71) Applicant: Ferro GmbH, Frankfurt (DE)

(72) Inventors: Jürgen Hanich, Königstein (DE); Lothar Heck, Frankfurt (DE); Andreas Schulz, Karben (DE); Julian Schütze, Oberursel (DE)

(21) Appl. No.: 16/417,687

(22) Filed: May 21, 2019

Related U.S. Application Data
(62) Division of application No. 14/715,686, filed on May 19, 2015.

(30) Foreign Application Priority Data
May 30, 2014 (DE) 102014008310.1

(51) Int. Cl. C09D 183/04; B05D 3/12; C09D 183/06; C03C 17/30

(52) U.S. Cl. CPC C09D 183/04; B05D 3/12; C09D 183/06; C03C 17/30; C08G 77/16; Y10T 428/31663; C03C 2218/114; C03C 2218/32; Y10T 428/31612

(57) ABSTRACT

The present invention pertains to a coating composition for the coating of a substrate such as a mirror or a glass. The invention is characterized in that the coating composition comprises a polyalkylsiloxane with terminal hydroxyl groups or a mixture of different polyalkylsiloxanes with terminal hydroxyl groups, silicon tetrahalide or alkyl halogen silane or mixtures thereof, and an inert aprotic.

### CROSS-REFERENCE TO RELATED APPLICATIONS

This application is a divisional application of copending U.S. application Ser. No. 14/715686 filed May 19, 2015, which claimed priority to German application DE102014008310.1 filed May 30, 2014, both of which are expressly incorporated herein by reference.

### FIELD OF THE INVENTION

The present invention pertains to a coating composition which reduces the adherence of dust to glass and mirror surfaces. Moreover, the present invention pertains to its preparation, to a substrate provided with the coating composition, to the coating method, and to the use of the coating compositions according to the invention.

### PRIOR ART

Dust and dirt repelling coatings on mirror and/or glass surfaces are essential in particular for solar installations and solar-thermal power plants where parabolic mirrors are used, for a constant high efficiency.

Solar-thermal power plants are thermal solar installations which harvest thermal energy from solar energy and turn it into solar current. The electromagnetic radiation of the sun is transformed into thermal energy. The radiant energy is given off in the form of quanta of radiation, so-called photons. When these photons strike a body, they are absorbed or reflected. In the case of absorption, the atoms of the body are placed in oscillations by the photons, thus producing heat. There are several kinds of solar-thermal power plants, such as solar farm, solar tower, and parabolic trough power plants, which operate by concentrating the direct radiation of the sun. Electricity is then produced via a heat exchanger and generator.

In the prior art there is a multitude of patents pertaining to dust and dirt repelling coatings.

Thus, for example, substrates exposed to contamination with dust having inorganic and organic components or soot and smoke, which for the most part consist of carbon, are treated with a hydrophobic coating which is dust and dirt repelling for at least a certain length of time. Coatings are also used with a certain self-cleaning effect by the familiar “lotus blossom” principle. However, the coatings known in the prior art are always only dust and dirt repelling for a certain length of time.

DE 10 2007 039 164 A1 describes a substrate coating which repels dust and can easily be cleaned of adhering inorganic and organic dirt with rain water. The coating material mentioned there contains first oxide particles of silane tetra or trialkoxides in a size range of 5-20 nm and second particles with a diameter in the size range of 80-300 nm, which can be chosen from among aluminum, silicon and titanium oxides, for example.

WO2011/031138 A2 describes a method for coating a transparent substrate with a dirt-repelling layer, wherein a silicate layer is deposited by means of plasma deposition. A first precursor containing an organosilane compound is mixed with a solvent to form a sol-gel preparation, which is applied to the substrate in the form of a film to form the coating.

WO2007/102960 A2 discloses a hydrophobic self-cleaning coating composition which contains pyrogenic silicic acid in a size range of 1000 to 4000 nm, a solvent or mixture of solvents chosen from hydrocarbons or linear or cyclical polydimethylsiloxanes with 2 to 10 dimethylsiloxy units. The hydrophobic properties are the result of a suitable hydrophobizing treatment, i.e., the treatment with at least one compound from the group of organosilanes, alkylsilanes, fluorinated silanes and/or disilazanes.

WO2008/027697 A1 describes perfluoropolyethersilanes, compositions which contain the perfluoropolyethersilanes and methods for treatment of substrates, especially substrates with a hard surface such as ceramics or glass, in order to make them water, oil, or dirt repellent.

WO2011/043973 A1 describes a coating composition which comprises a silsesquioxane hard coating resin component and a perfluoropolyethersilane as well as a method for the coating of substrates, especially substrates with a hard surface such as ceramics, metal or glass, in order to make them water, oil, or dirt repellent.

WO2008/027698 A1 describes an antireflection object, which comprises a substrate with an antireflection surface and a coating of a perfluoropolyethersilane thereon, and furthermore a method for applying a dirt-resistant coating on a substrate with an antireflection surface.

### The Problem

The problem to be solved by the invention is to discover a coating material which is easy to produce and furthermore economical. This coating material after being applied to a substrate such as glass or a mirror or other surface should produce a layer which steadily reduces the adherence of dust to the surfaces. The surface treated with the coating should also have a certain scratch resistance, as well as a resistance to moisture.

### DETAILED SPECIFICATION OF THE INVENTION

Surprisingly, it is possible to solve this problem by the preparation of a coating composition which comprises a polyalkylsiloxane with terminal hydroxyl groups or a mixture of different polyalkylsiloxanes with terminal hydroxyl groups, silicon tetrahalide or alkyl halogen silane or mixtures thereof, and an inert aprotic solvent.

As the polyalkylsiloxane one preferably uses polydimethylsiloxane silanol terminated (PDMS). However, this choice is not restrictive and any other polyalkylsiloxanes with terminal hydroxyl groups can be used. As examples one can mention poly(methylpropyl)siloxane, poly(methyloctyl)siloxane, poly(trifluoropropylmethyl)siloxane and poly(phenylmethyl)siloxane.

The silicon tetrahalide can be chosen from silicon tetrachloride or silicon tetrabromide, giving preference to silicon tetrachloride.

The alkyl halogen silane is chosen from among methyltrichlorsilane, dimethyldichlorosilane, chlorpropyltrichlorosilane, and dodecyltrichlorosilane or the corresponding bromine compounds, this list being in no way exhaustive.

The inert aprotic solvent is an aliphatic or cycloaliphatic or aromatic hydrocarbon or an ether.

The solvent is preferably an isoparaffin.

As the substrate one will use a glass or a mirror, especially a parabolic mirror. But other surfaces which need to be provided with a dust-repelling surface are also included. For example, substrates which are used in the flat glass industry or coatings on desktops, touchpanels, etc.

The preparation of the coating composition is characterized by the following steps:
Preparation of a polyalkylsiloxane with terminal hydroxyl groups or a mixture of various polyalkylsiloxanes with terminal hydroxyl groups in an inert aprotic solvent, and
adding of silicon tetrahalide or alkyl halogen silane or mixtures thereof in an inert aprotic solvent.

The method for preparation of the coated substrate is characterized by the following steps:
Application of the prepared coating composition to the substrate,
Removal of excess coating composition on the substrate after 1-10 minutes,
Drying of the coating composition on the substrate and
Polishing of the coating composition on the substrate.

The coating composition is applied to the substrate by means of a dip method, film drawing frame, spiral doctor blade, roller or spray gun.

An excess of the coating composition is wiped off with a doctor blade or cloth or blown away with air.

Preferably the excess coating composition is removed after one minute.

After this, the coating composition is dried for 5 to 120 minutes, preferably 30 minutes at a temperature in the range of 20 to 150° C., preferably 120° C.

After the drying process, the surface of the coating is polished with a microfiber cloth.

Also described is the use of the coating composition for the coating of a substrate with a coating composition which is dust-repellent and scratch-resistant.

The substrate here is a glass or a mirror. A use is intended for parabolic mirrors for solar thermal power plants, among other things.

The invention is further described below by means of examples and sample embodiments, which do not limit the scope of the invention.

Various chlorosilanes are tested in combination with PDMS for the coating of solar glass. Only single coatings are prepared. Each experiment is conducted twice.

The following solutions in Exxol D80 are used:

| Silane | g/mol solution concentration | | |
|---|---|---|---|
| PDMS (Polydimethylsiloxane | 680 | A | 4.2% |
| silanol terminated) | | | |
| DCMS (Dimethyldichlorosilane) | 129 | B2 | 1.8% |
| SiCl₄ | 170 | C2 | 1.18% |
| | | C3 | 1.58% |
| | | C4 | 2.37% |
| Trichloromethylsilane (TCMS) | 149 | D2 | 1.39% |
| | | D3 | 2.08% |
| Chloropropyltrichlorosilane (CPTCS) | 212 | E2 | 1.97% |
| | | E3 | 2.96% |
| Dodecyltrichlorosilane (DCTS) | 304 | F2 | 2.82% |
| | | F3 | 4.24% |
| C₈F₁₃H₄SiCl₃ (TDH40) | 482 | G2 | 4.48% |
| | | G3 | 6.72% |

Silane Treatment
Cleaning of the 10 cm×10 cm×2 mm panes, blowing with air
Mix all solutions (B-G) freshly with solution A in the indicated proportion and apply with lacquer doctor blade (24 μm)
After 1 min, rub and wipe off with a cloth
Drying at 120° C. for 5 to 60 min, preferably 30 min
Let cool down
Polish with microfiber cloth

Test Method

The polished plates are all half stressed (100 cycles), then placed in the 90° water bath for 1 h, blown off with air and dried. After this, the standard dust test is carried out (15 min).

For example, A-B2 (1:1) means: 4.2% solution of PDMS in Exxol D80 is mixed with a 1.8% solution of DCMS in Exxol D80 in a ratio of 1:1 and so used.

The mixture A-B2 and the other mixtures have to be prepared fresh prior to the application, since the contents react with each other, albeit slowly.

The dust test was conducted with iron oxide hydroxide (FeOOH). After this, a color measurement (CIELAB) of the dusted glass plate was done with a colorimetry instrument from the company Datacolor Model Mercury as compared to the undusted glass plate. The lower the ΔE value is, the less FeOOH clings to the glass plate. Results with ΔE values <3 (stressed {(100) cycles/90°} and unstressed {(90°-1 h)}) are examples, results with βE values >3 are comparison examples (here, experiments 7, 8, 11, 12 and 15).

| | | ΔE | ΔE (100 | |
|---|---|---|---|---|
| | Silane | (90° C. - | cycles/ | |
| Experiment | solutions | 1 h) | 90° C.) | Comment |
| 1a | A-B2 (1:1) | 0.2 | 0.6 | |
| 1b | A-B2 (1:1) | 0.2 | 1.0 | |
| 2a | A-C2 (1:1) | 0.5 | 0.6 | |
| 2b | A-C2 (1:1) | 0.6 | 0.7 | |
| 3a | A-C3 (1:1) | 0.5 | 0.5 | |
| 3b | A-C3 (1:1) | 0.5 | 0.7 | |
| 4a | A-C4 (1:1) | 0.4 | 0.4 | |
| 4b | A-C4 (1:1) | 1.0 | 7.6 | |
| 4a2 | A-C4 (1:1) | 0.4 | 0.7 | Repetition 4a |
| 4b2 | A-C4 (1:1) | 0.4 | 1.2 | Repetition 4b |
| 5a | A-D2 (1:1) | 0.8 | 0.8 | |
| 5b | A-D2 (1:1) | 4.1 | 0.6 | |
| 5a2 | A-D2 (1:1) | 0.6 | 4.4 | Repetition 5a |
| 5b2 | A-D3 (1:1) | 0.7 | 1.1 | Repetition 5b |
| 6a | A-D3 (1:1) | 2.2 | 0.9 | |
| 6b | A-E2 (1:1) | 2.3 | 0.7 | |
| 7a | A-E2 (1:1) | 25.6 | 2.3 | Gray film after |
| | | | | drying |
| 7b | A-E2 (1:1) | 13.6 | 2.2 | |
| 8a | A-E3 (1:1) | 20.2 | 2.1 | Gray film after |
| | | | | drying |
| 8b | A-E3 (1:1) | 16.4 | 3.2 | |
| 9a | A-F2 (1:1) | 0.3 | 0.2 | |
| 9b | A-F2 (1:1) | 0.4 | 0.2 | |
| 10a | A-F3 (1:1) | 0.3 | 0.2 | |
| 10b | A-F3 (1:1) | 0.7 | 0.7 | |
| 11a | A-G2 (1:1) | 0.6 | 3.6 | Turbidity, |
| | | | | precipitates |
| | | | | white |
| 11b | A-G2 (1:1) | 0.6 | 3.8 | |
| 12a | A-G3 (1:1) | 0.5 | 3.5 | Turbidity, |
| | | | | precipitates |
| | | | | white |
| 12b | A-G3 (1:1) | 0.3 | 5.2 | |
| 13a | A-B2-C2 | 1.0 | 1.0 | |
| | (4:3:1) | | | |
| 13b | A-B2-C2 | 0.5 | 0.7 | |
| | (4:3:1) | | | |
| 14a | A-B2-D2 | 0.3 | 0.6 | |
| | (4:3:1) | | | |
| 14b | A-B2-D2 | 0.1 | 0.8 | |
| | (4:3:1) | | | |
| 15a | A-B2-E2 | 1.2 | 2.7 | |
| | (4:3:1) | | | |
| 15b | A-B2-E2 | 1.7 | 3.8 | |
| | (4:3:1) | | | |
| 16a | A-B2-F2 | 0.4 | 0.8 | |
| | (4:3:1) | | | |
| 16b | A-B2-F2 | 0.3 | 0.5 | |
| | (4:3:1) | | | |

Another point of the invention is that a glass plate or a mirror which have been coated according to the method of the invention, if their dust repelling properties diminish over time, can be coated once more after cleaning the surface and thus the dust repelling properties can be regenerated once more. This regeneration should be done in the installed condition. This means that all work steps occur as during the basic coating except for the step of drying at high temperatures. However, it is to be assumed that sunlight can already compensate for the drying step, so that the drying time might simply be longer. Optionally, the after-coated glass pane or mirror have to be additionally heated with an IR lamp or a hot air blower. In the laboratory, a drying at 60° C. for 60 min showed good results for the after-coating.

Example: after the coating with PDMS/DCMS similar to the coating in example 1, the ΔE value after polishing was 1.3 (0.6). The glass pane was then placed in a 90° C. hot water bath for 12 hours. After this, the ΔE value was 8.5 (8.8). It was then after-coated with PDMS/DMCS, and dried for 60 min at 60° C. After polishing, the ΔE value was 1.1 (1.9). The values in brackets are the ΔE values for the half pane that was stressed with 100 cycles, the values without brackets are the ΔE values for the half pane that was not stressed.

1. A method of providing a dust repellent surface to a substrate, the method comprising:
preparing a coating composition including
(a) a polyalkylsiloxane with terminal hydroxyl groups or a mixture of different polyalkylsiloxanes with terminal hydroxyl groups,
(b) silicon tetrahalide, alkyl halogen silane, or mixtures thereof, and
(c) an inert aprotic solvent;
applying the coating composition to a substrate; and
drying the coating composition on the substrate to form the dust repellant surface on the substrate.

2. The method according to claim 1, further including removing an excess of coating composition from the substrate at 1-10 minutes after the applying step, and before the drying step.

3. The method according to claim 2, wherein the excess of coating composition is removed from the substrate using a doctor blade, a cloth, or blown air.

4. The method according to claim 1, further including polishing the dust repellant surface.

5. The method according to claim 4, wherein the polishing is performed using a microfiber cloth.

6. The method according to claim 1, wherein the coating composition is applied to the substrate by at least one selected from the group consisting of film drawing frame, spiral doctor blade, roller gun, spray gun, and dipping.

7. The method according to claim 1, wherein the coating composition is dried in the drying step by heating the coating composition to a temperature in a range of 20-150° C. for 5-120 minutes.

8. The method according to claim 1, wherein the coating composition is prepared by:
mixing the polyalkylsiloxane with terminal hydroxyl groups or the mixture of different polyalkylsiloxanes with terminal hydroxyl groups into the inert aprotic solvent, and
adding the silicon tetrahalide or the alkyl halogen silane or mixtures thereof into the inert aprotic solvent.

9. The method according to claim 1, wherein the (a) polyalkylsiloxane with terminal hydroxyl groups or the mixture of different polyalkylsiloxanes with terminal hydroxyl groups includes:
silanol terminated polydimethylsiloxane,
silanol terminated poly(methylpropyl)siloxane,
silanol terminated poly(methyloctyl)siloxane,
silanol terminated poly(trifluoropropylmethyl)siloxane,
silanol terminated poly(phenylmethyl)siloxane, or
combinations thereof.

10. The method according to claim 9, wherein the (a) polyalkylsiloxane with terminal hydroxyl groups or the mixture of different polyalkylsiloxanes with terminal hydroxyl groups consists of silanol terminated polydimethylsiloxane.

11. The method according to claim 1, wherein the (b) silicon tetrahalide, alkyl halogen silane, or mixtures thereof includes:
silicon tetrachloride,
silicon tetrabromide,
methyltrichlorosilane,
dimethyldichlorosilane,
chlorpropyltrichlorosilane,
dodecyltrichlorosilane,
methyltribromosilane,
dimethyldibromosilane,
chlorpropyltribromosilane,
dodecyltribromosilane, or
combinations thereof.

12. The method according to claim 11, wherein the (b) silicon tetrahalide, alkyl halogen silane, or mixtures thereof consists of silicon tetrachloride or silicon tetrabromide.

13. The method according to claim 11, wherein the (b) silicon tetrahalide, alkyl halogen silane, or mixtures thereof consists of:
methyltrichlorosilane,
dimethyldichlorosilane,
chlorpropyltrichlorosilane,
dodecyltrichlorosilane,
methyltribromosilane,
dimethyldibromosilane,
chlorpropyltribromosilane,
dodecyltribromosilane, or
combinations thereof.

14. The method according to claim 1, wherein the (c) inert aprotic solvent includes aliphatic hydrocarbon, cycloaliphatic hydrocarbon, aromatic hydrocarbon, ether, or combinations thereof.

15. The method according to claim 14, wherein the (c) inert aprotic solvent consists of isoparaffin.

16. The method according to claim 1, wherein the substrate includes glass or a mirror.

17. The method according to claim 1, wherein the substrate is a parabolic mirror.
